(19) United States
(12) Patent Application Publication
(10) Pub. No.: US 2005/0086003 A1
(43) Pub. Date: Apr. 21, 2005

(54) Method for collision avoidance and collision mitigation

(76) Inventors: M. Nabeel Tarabishy, Walled Lake, MI (US); Gerald H. Engelman, Plymouth, MI (US); Henrik Lind, Torslanda (SE); Alexander Modigsson, Gunnilse (SE); Levasseur Tellis, Southfield, MI (US); John Vincent Bond III, Inkster, MI (US)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/051,063

(22) Filed: Jan. 17, 2002

(51) Int. Cl. G08G 1/16

(52) U.S. Cl. 701/301; 340/903; 340/436

(57) ABSTRACT

An adaptive cruise control system includes a forward-looking sensor generating a range signal corresponding to a distance between the host vehicle and a target vehicle. The forward-looking sensor also generates a range rate signal corresponding to a rate that the distance between the host vehicle and the target vehicle is changing. A controller is electrically coupled to the forward-looking sensor. The controller maintains a preset headway distance between the host vehicle and the target vehicle by adjusting the host vehicle velocity in response to the range signal and the range rate signal. The host vehicle may come to a full stop when the target vehicle is acquired below a predetermined velocity. If the target vehicle is acquired above the predetermined velocity, then a warning is given when braking is required.

### TECHNICAL FIELD

The present invention relates to a method for avoiding collisions and collision mitigation involving vehicles and other objects. Specifically, the method is focused on predicting the probability density function for said vehicles and objects.

### BACKGROUND OF THE INVENTION

Several methods have been developed for collision avoidance utilizing sensors to obtain values such as distance, speed and direction of objects and vehicles.

U.S. Pat. No. 4,623,966 discloses an apparatus for collision avoidance for marine vessels. This apparatus comprises sensing means for providing signals representative of the positions and velocities of other vehicles relative to a first vehicle. These signals are used in a deterministic way to assess maneuvers of the first vehicle, which will avoid collision with the other vehicles. Collision danger is assessed through measures such as closest passing point, predicted point of collision and predicted areas of danger.

Radar and laser are utilized in the invention disclosed in U.S. Pat. No. 5,471,214 to detect objects within a specific range of the vehicle equipped with the collision avoidance system. The Kalman filter is used to estimate relative future positions of the vehicles. A maximum danger region is defined and presence of an object in this region results in an alarm signal. Further, the invention is focused on the sensor set-up.

A similar system is disclosed in U.S. Pat. No. 5,596,332. The Kalman filter is utilized to predict future probable positions of aircrafts. If the future probable position (a volume) at a specific time of an aircraft overlaps the future probable position at the same time for another aircraft, an alarm signal is generated. GPS is used to determine earth coordinates for the aircrafts.

U.S. Pat. No. 6,026,347 discloses a method for use in vehicles to avoid collisions with obstacles. The method applies to automated vehicles driving in the same direction in two or more lanes. Each vehicle includes a processor that is coupled to the vehicle's braking, steering and engine management systems that can accept commands from other vehicles to brake, accelerate, or change lanes. The invention mainly concerns how coordination of maneuvers between several vehicles during avoidance maneuver should be managed.

In U.S. Pat. No. 6,085,151 a collision sensing system is disclosed where the probability of threat and the type of threat are computed, the result of which is used to perform an appropriate action, such as seat belt pre-tensioning, airbag readying and inflating, and braking. Thus, the main focus of the patent is preparing the vehicle for collision in order to enhance the safety. Individual targets are identified by clustering analysis and are tracked in a Cartesian coordinate system using a Kalman filter.

According to a paper by Jocoy et al, “Adapting radar and tracking technology to an on-board automotive collision warning system”, in: The AIAA/IEEE/SAE Digital Avionics systems Conference, 1998, Vol. 2, pp I24-1-I24-8, the intersection collisions constitute approximately twenty-six percent of all accidents in the United States. A system is under development, which consists of a single radar assembly that will monitor vehicle traffic along the approaching lanes of traffic. A metric of gap time based on predicted time of arrival at the intersection is used to provide a warning to the driver. The measure used to detect threats is predicted as time to and out of the intersection.

A prediction system, which allows the evaluation of collision and unhooking risks in the automatic control of truck platoons on highways, is described in a paper by Attouche et al, “A prediction system based on vehicle sensor data in automated highway”, In: 2000 IEEE Intelligent Transportation Systems, Conference Proceedings, 1-3 October 2000, pp 494-499. The system applies to a concentration of trucks traveling in the same direction for long distances and comprises an inter-truck spacing signal obtained by a triple measurement device: a laser range-finder, an embedded camera and a theoretical observer, based on system dynamic equations.

A paper by Seki et al., “Collision avoidance system for vehicles applying model predictive control theory”, In: 1999 IEEE/IEEJ/JSAI International Conference on Intelligent Transportation Systems, pp 453-458, describes a similar system for avoiding collisions with vehicles or objects traveling in the same direction as the vehicle equipped with the collision avoidance system. What is discussed is mainly how to control the braking force, given some target stopping point which is given by some safe deceleration rate plus surplus distance.

All of the above described prior art collision avoidance systems and methods either are dependant of external signal transmitters, for example GPS satellite communication or communication between vehicles equipped with collision avoidance systems, or they result in giving alarm signals too frequently when implemented in an automobile. All of the prior art systems or methods have difficulties handling situations like a vehicle meeting another vehicle traveling in the opposite direction on a two way road. If a collision avoidance system or method were to give an alarm signal every time the vehicle equipped with such a system meets another vehicle, this would be a nuisance to the driver and could result in the driver shutting down the collision avoidance function and not using it at all.

### SUMMARY OF THE INVENTION

The foregoing and other advantages are provided by a method and apparatus for collision avoidance and collision mitigation. The present invention relates to a method for avoiding vehicle collisions and collision mitigation. The method comprises the steps of predicting the probability density function (11, 12, 13, 14) for the position of a vehicle at several future occasions and predicting the probability density function (21, 22, 23, 24) for at least one additional object at several future occasions. Further the method comprises the step of forming the joint probability density function for the relative positions of the vehicle and object at several future occasions and integrating over the area in which the vehicle and object are in physical conflict.

The present invention itself, together with attendant advantages, will be best understood by reference to the following detailed description, taken in conjunction with the accompanying figures.

### BRIEF DESCRIPTION OF THE DRAWINGS

In order that the invention may be well understood, there will now be described some embodiments thereof, given by way of example, reference being made to the accompanying drawings, in which:

FIG. 1 shows a top view of two vehicles meeting on a straight road;

FIG. 2 shows a three-dimensional plot of the probability density functions for the vehicles in FIG. 1 at four different times;

FIGS. 3a and 3b show the probability density function in one direction for each of the two vehicles respectively at the four different times shown in FIG. 2;

FIGS. 4a-4d show for each of the four times in FIG. 2 the probability density function in one direction for each of the two vehicles; and

FIGS. 5a-5d show the joint probability function in one direction for the two vehicles at the four different times shown in FIG. 2.

### BEST MODES FOR CARRYING OUT THE INVENTION

The method according to the invention will be explained with reference made to an example illustrated in the enclosed figures. The example is chosen in order to facilitate the reading and understanding of the method according to the present invention. Therefore, most of the diagrams in the figures show the probability density functions in one direction.

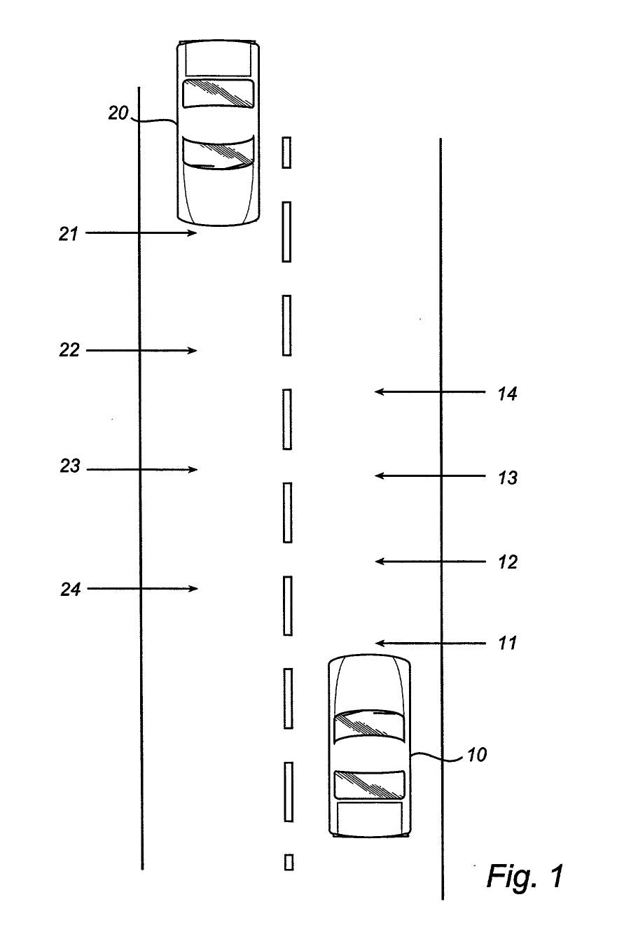

FIG. 1 illustrates a common situation with two vehicles meeting on a straight road. The vehicle equipped with the collision avoidance system is denoted 10 and the other vehicle is denoted 20. Throughout the example the probability density function has been calculated for both the vehicles at four future occasions (the same for both vehicles) The four future occasions are denoted 11, 12, 13 and 14, for the vehicle equipped with the collision avoidance system, with the same time interval between the future occasions. For the other vehicle the four future occasions are denoted 21, 22, 23 and 24. The occasion 11 for the first said vehicle corresponds to occasion 21 for the other said vehicle and so forth for 12, 13 and 14. A time increment of 0.05 s in the example results in the velocities ˜70 km/h and ˜100 km/h (˜45 mph and ˜mph) for the vehicle equipped with the collision avoidance system and the other vehicle respectively.

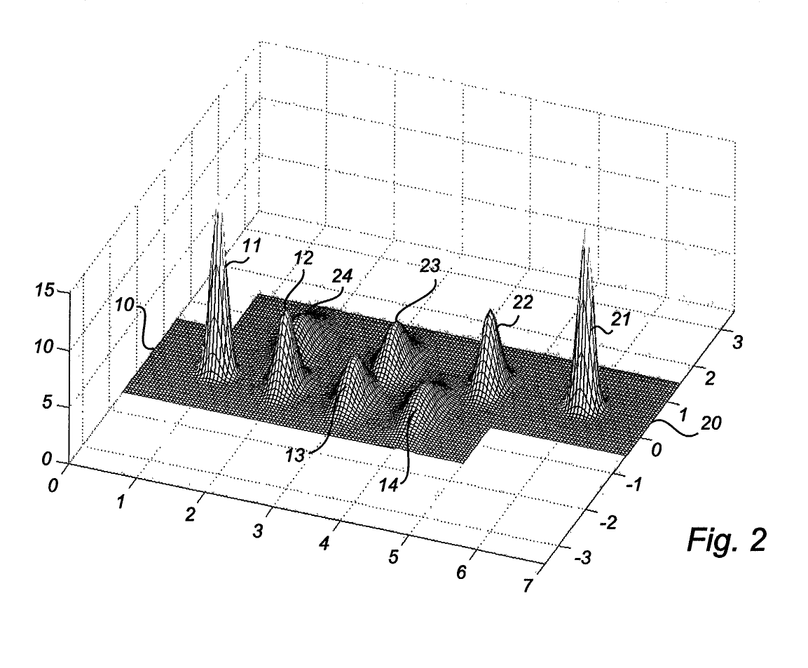

In FIG. 2 the probability density functions have been calculated for the vehicles at the four said future occasions and they are illustrated in this three-dimensional plot. The probability density functions 11 and 21 are the ones closest in time to the present location and thus the peaks are higher than for the functions 12, 13, 14, 22, 23 and 24, i.e. the probabilities are high for the vehicles to be in this area. Contrary, the peaks of the probability density functions 14 and 24 are lower but the functions are on the other hand wider, i.e. the further away in the future the more alternative positions. The probability that the vehicle ends up in a specific position is lower since the time difference between the present position and the future position is long and therefore larger changes can occur, for example changes in direction and velocity.

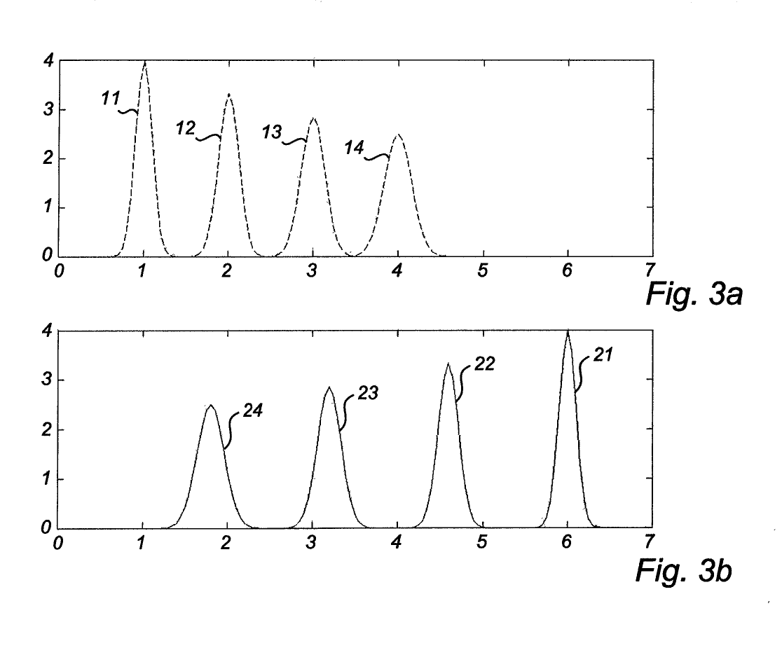

In FIG. 3a the probability density functions are shown in the direction of the vehicle equipped with the collision avoidance system at the four future occasions. FIG. 3b illustrates the corresponding probability density functions for the other vehicle.

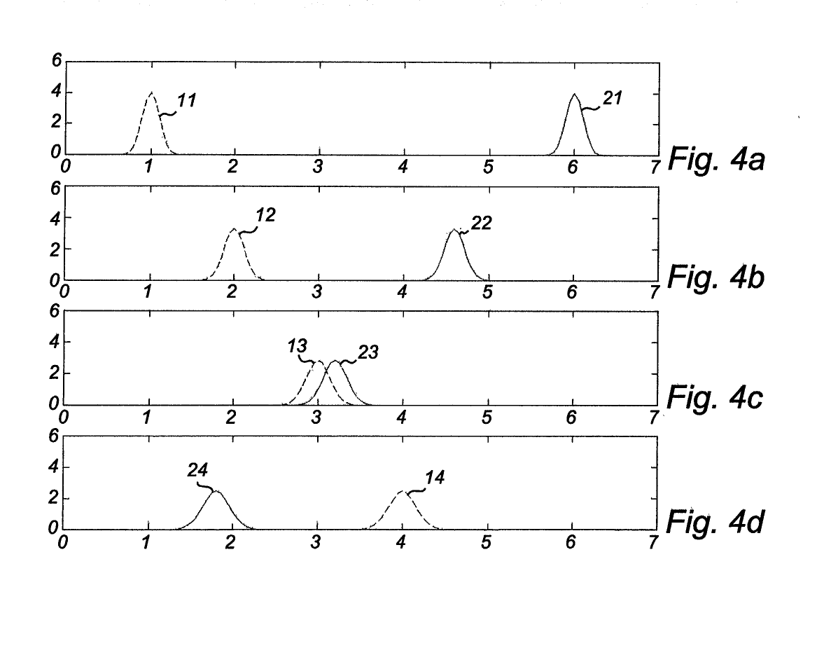

In FIGS. 4a-4b the probability density functions have been divided up into four separate diagrams showing the probability density functions for both vehicles but where one diagram illustrates only one point in time. Thus, FIG. 4a shows the probability density functions 11 and 21, the closest in time to the present positions of the vehicles. Hence, the diagram in FIG. 4b shows the probability density functions 12 and 22, the diagram in FIG. 4c shows the probability density functions 13 and 23 and the diagram in FIG. 4d shows the probability density functions 14 and 24. Preferably the time intervals are chosen short. In FIG. 4c the probability density functions of the vehicles partly overlap each other. If, for example, the time interval had been twice as long (FIGS. 4b and 4d) the probability density functions would pass each other, which then would result in a possible danger not being discovered. However, the calculations are repeated continuously with a frequency large enough to avoid such risks.

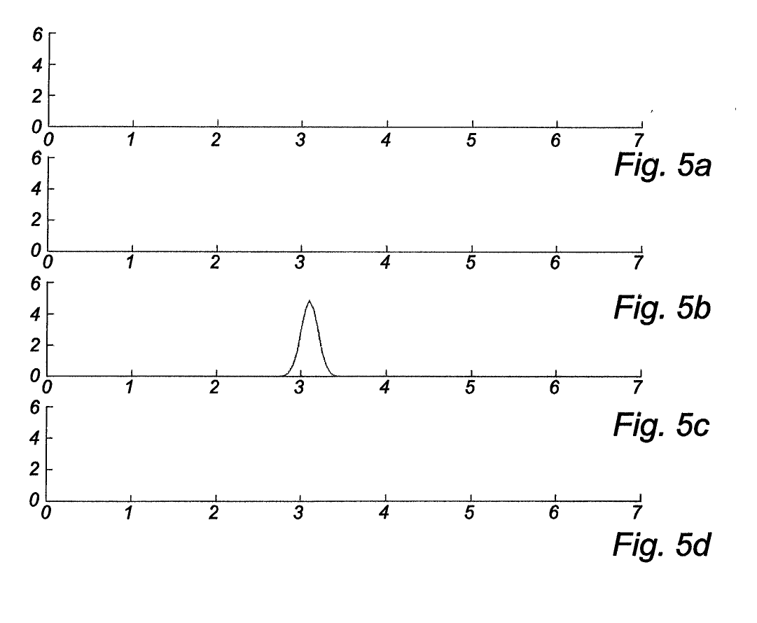

Some prior art calculations are carried out in a similar way, i.e. the probability density functions are calculated for the vehicles. However, using prior art on the example here would result in an alarm caused by the overlapping probability density functions 13 and 23 in FIG. 2 if the confidence interval is large. It is not desirable for a driver of a vehicle equipped with a collision avoidance system to have a warning signal every time said vehicle meets another vehicle in a situation similar to that in the example shown. The confidence interval might be chosen not to give warning signals in specific situations, but this will result in a relatively insensitive system that will fail to warn in some situations where a warning signal should be the result. According to the present invention a joint probability density function is therefore calculated for each of the future occasions. FIGS. 5a-5d show the joint probability density functions for one direction (traveling direction) in the example with four future occasions. The joint probability density function is integrated over the area in which the vehicle and object are in physical conflict. The output of the calculation indicate the probability of collision. However, FIG. 5c is the only figure showing any signal at all. Preferably a preset limit of when to alarm is chosen higher than the calculated probability in the example, since the situation is not one where an alarm signal is desired. An alarm signal in a normal situation like this when the probability of collision is very low would be most annoying to the driver. However, the example shows only the probability density functions in only one direction. The probability of collision taking two dimensions into consideration, in the example illustrated, is much lower. The probability density functions 13 and 23 seen along the traveling direction in FIG. 2 barely overlap. On the other hand, seen from the direction perpendicular to the traveling direction, as shown in FIG. 4c, the probability density functions overlap considerably.

Thus, the probability of collision for the vehicle and each of the surrounding objects should be calculated for a sufficient number of future occasions. Based on this, rules are set in the probability domain on when to take evasive action or brake. The probability density function can for example be calculated by using the extended Kalman filter to predict the vehicles and surrounding objects future positions as well as their associated covariance matrix. The following is an example describing such a calculation. Calculating the probability density function using the Kalman filter is a relatively simple method. Much more sophisticated methods can be used instead but the simple method is used to facilitate the understanding of the concept according to the present invention. The algorithm uses the following discrete state space description for the vehicle and other objects:

$${X}_{t} = ( \begin{matrix}{x}_{t} \\ {y}_{t} \\ {v}_{x , t} \\ {v}_{y , t} \\ {ω}_{t}\end{matrix} )$$

where:
xₜ=xₜ coordinate in a ground fixed coordinate system
yₜ=yₜ coordinate in a ground fixed coordinate system
v_{x,t}=velocity in the x direction
v_{y,t}=velocity in the y direction
ωₜ=rate of direction change

$$\begin{matrix}{X}_{t + T} = ( \begin{matrix}1 & 0 & \frac{sin ( {ω}_{t} T )}{{ω}_{t}} & \frac{- ( 1 - cos ( {ω}_{t} T ) )}{{ω}_{t}} & \frac{{v}_{x} T cos ( {ω}_{t} T )}{( {ω}_{t} - sin ( {ω}_{t} T ) ) {ω}_{t}^{2}} - \frac{{v}_{y} T sin ( {ω}_{t} T )}{( {ω}_{t} - ( 1 - cos ( {ω}_{t} T ) ) ) {ω}_{t}^{2}} \\ 0 & 1 & \frac{1 - cos ( {ω}_{t} T )}{{ω}_{t}} & \frac{sin ( {ω}_{t} T )}{{ω}_{t}} & \frac{{v}_{x} T sin ( {ω}_{t} T )}{{ω}_{t} - ( 1 - cos ( {ω}_{t} T ) {ω}_{t}^{2} )} - \frac{{v}_{y} T cos ( {ω}_{t} T )}{{ω}_{t} - sin ( {ω}_{t} T ) {ω}_{t}^{2}} \\ 0 & 0 & cos ( {ω}_{t} T ) & - sin ( {ω}_{t} T ) & - {v}_{x} T sin ( {ω}_{t} T ) - {v}_{y} T cos ( {ω}_{t} T ) \\ 0 & 0 & sin ( {ω}_{t} T ) & cos ( {ω}_{t} T ) & {v}_{x} T cos ( {ω}_{t} T ) - {v}_{y} T sin ( {ω}_{t} T ) \\ 0 & 0 & 0 & 0 & 1\end{matrix} ) {X}_{t} \\ = {AX}_{t}\end{matrix}$$

The extended Kalman filter is used to predict the future positions of the vehicle and the objects. The Kalman filter prediction is iterated n times to obtain the vehicles position at the times T, 2T, . . . , nT. For example, n is chosen so that nT is the same or slightly longer than the time it takes to come to a full stop given the speed, braking capabilities and the tire to road friction of the vehicle.

The main purpose of the decision-making algorithm is to get a measure of when to execute an avoidance maneuver or to make an alarm. The probability of the future positions of the vehicle and the object/objects being close to one another in the X and Y direction can be calculated as follows (in this example the coordinate system is fixed to the collision avoidance vehicle):

$${P}_{x} ( \vert Δ X \vert < a + b ) = {\int }_{- a - b}^{a + b} f ( Δ X )$$

$${P}_{y} ( \vert Δ Y \vert < c + d ) = {\int }_{- c - d}^{c + d} f ( Δ Y )$$

where:
ΔX=distance between the vehicle and the object in the X direction
ΔY=distance between the vehicle and the object in the Y direction
a=half the width of the vehicle
b=half the width of the object
c=half the length of the vehicle
d=half the length of the object

$$f ( Δ X ) = \frac{1}{{σ}_{x} \sqrt{2 π}} {ⅇ}^{\frac{- Δ {X}^{2}}{2 {σ}_{x}^{2}}} = the probability density function of Δ X$$

$$f ( Δ Y ) = \frac{1}{{σ}_{y} \sqrt{2 π}} {ⅇ}^{\frac{- Δ {Y}^{2}}{2 {σ}_{y}^{2}}} = the probability density function of Δ Y$$

σₓ and σ_{y} are given by the (1, 1) and (2, 2) elements of the covariance matrix of Xₜ, Pₜ. The threshold for collision avoidance maneuver can be set to alarm when the probability Pₓ and P_{y} are greater than some values Tₓ and T_{y}. Tₓ and T_{y} are design parameters who should be dependent on the velocity of the vehicle.

The foregoing is a disclosure of an example practicing the present invention. However, it is apparent that method incorporating modifications and variations will be obvious to one skilled in the art. Inasmuch as the foregoing disclosure is intended to enable one skilled in the art to practice the instant invention, it should not be construed to be limited thereby, but should be construed to include such modifications and variations as fall within its true spirit and scope.

1. An apparatus for avoiding vehicle collisions comprising:
a forward-looking sensor generating a forward-looking signal corresponding to the relative positions between a host vehicle and a target object;
a yaw rate sensor generating a yaw rate signal corresponding to the angular position of said host vehicle relative to said target object; and
a controller electrically coupled to said forward-looking sensor and said yaw rate sensor, said controller receiving said forward-looking signal and said yaw rate signal, said controller including control logic operative to predict the probability density function for the position of a vehicle at several future occasions, predict the probability density function for the position of said additional object at several future occasions, form the joint probability density function for the relative positions of the vehicle and object at said several future occasions, and integrate the joint probability density function over the area in which the vehicle and the object are in physical conflict based upon said forward-looking signal and said yaw rate signal.

2. The apparatus as recited in claim 1, wherein said target object is a vehicle.

3. The apparatus as recited in claim 1, wherein said object is a fixed object.

4. The apparatus as recited in claim 1, wherein the probability density function is predicted for several vehicles, fixed objects and moving objects.

5. The apparatus as recited in claim 1, wherein said forward-looking signal corresponds to the total width and length of the vehicle and the object.

6. The apparatus as recited in claim 1, wherein said probability density function is approximated with the Gaussian normal distribution.

7. The apparatus as recited in claim 1, wherein the probability density function is calculated using the Kalman filter.

8. The apparatus as recited in claim 7, wherein the Kalman filter is used to calculate the covariance matrix of the vehicle and the object.

9. The apparatus as recited in claim 1, wherein the method also comprises the step of taking a suitable cause of action for the specific situation.

10. A method for avoiding vehicle collisions comprising the steps of:
generating a forward-looking signal corresponding to the relative positions between a host vehicle and a target object;
generating a yaw rate signal corresponding to the angular position of said host vehicle relative to said target object;
predicting the probability density function for the position of a vehicle at several future occasions;
predicting the probability density function for the position of said additional object at several future occasions;
forming the joint probability density function for the relative positions of the vehicle and object at said several future occasions; and
integrating the joint probability density function over the area in which the vehicle and the object are in physical conflict based upon said forward-looking signal and said yaw rate signal.

11. The method as recited in claim 1, wherein said target object is a vehicle.

12. The method as recited in claim 1, wherein said object is a fixed object.

13. The method as recited in claim 1, wherein the probability density function is predicted for several vehicles, fixed objects and moving objects.

14. The method as recited in claim 1, wherein said forward-looking signal corresponds to the total width and length of the vehicle and the object.

15. The method as recited in claim 1, wherein said probability density function is approximated with the Gaussian normal distribution.

16. The method as recited in claim 1, wherein the probability density function is calculated using the Kalman filter.

17. The method as recited in claim 7, wherein the Kalman filter is used to calculate the covariance matrix of the vehicle and the object.

18. The method as recited in claim 1, wherein the method also comprises the step of taking a suitable cause of action for the specific situation.
